(19) United States
(12) Patent Application Publication
(10) Pub. No.: US 2012/0218162 A1
(43) Pub. Date: Aug. 30, 2012

(54) MULTIFREQUENCY ANTENNA

(75) Inventors: Yutaka Aoki, Ome-shi (JP); Shigeru Yagi, Nerima-ku (JP); Akira Saitou, Machida-shi (JP); Kazuhiko Honjo, Tsukuba-shi (JP)

(73) Assignees: The University fo Electro-Communications, Tokyo (JP); Casio Computer Co., Ltd., Tokyo (JP)

(21) Appl. No.: 13/505,041

(22) PCT Filed: Feb. 22, 2011
(86) PCT No.: PCT/JP2011/000993

§ 371 Date: Apr. 30, 2012

(30) Foreign Application Priority Data
Feb. 23, 2010 (JP) 2010-037956

(51) Int. Cl. H01Q 21/00; H01Q 5/00; H01Q 19/10

(52) U.S. Cl. 343/835; 343/893

(57) ABSTRACT

The multifrequency antenna comprises a substrate, antenna elements, shunt inductor conductors, series capacitor conductors, series inductor conductors, a connection point, and input/output terminals. The antenna elements are provided on the substrate and electrically connected to the connection point via the shunt inductor conductors. The antenna elements form capacitors together with the parts facing the series capacitor conductors and are electrically connected to the input/output terminals via these capacitors and series inductor conductors.

### TECHNICAL FIELD

This application relates generally to a compact multifrequency antenna transmitting/receiving radio signals of multiple frequencies with high efficiency.

### BACKGROUND ART

Various wireless communication systems such as wireless LANs and Bluetooth (registered trademark) have been in extensive use. Such wireless communication systems each have some advantages and disadvantages. Then, combinations of multiple wireless communication systems are generally utilized instead of using a single wireless communication system. Different wireless communication systems employ different frequency bands. Therefore, radio signals of multiple frequency bands should be transmitted/received for utilizing multiple communication systems. For transmitting/receiving radio signals of multiple frequencies, either multiple single-frequency antennas or a multifrequency antenna working with multiple frequencies should be used. However, a multifrequency antenna can be used more advantageously than multiple single-frequency antennas in realizing a compact, simple, and low cost antenna.

Patent Literature 1 discloses a multifrequency antenna. This multifrequency antenna comprises a conductor plate, a dielectric body provided on the conductor plate, and multiple antenna elements provided in contact with the dielectric body and having different properties. The multiple antenna elements operate at different frequency bands. Therefore, this single antenna can operate with multiple frequency bands.

However, having multiple antenna elements, the above multifrequency antenna requires a large space for installing the multiple antenna elements, increasing the antenna in size. Furthermore, it becomes complex in structure.

On the other hand, the present applicant has filed a compact multifrequency antenna composed of one antenna element and yielding large gains with multiple frequencies (Japanese Patent Application No. 2009-180009).

This multifrequency antenna comprises an antenna element, a first inductor connecting the antenna element and a grounding part, a feed point, and a series circuit comprising a second inductor and a capacitor and connecting the feed point and antenna element.

The inductances of the first and second inductors and the capacitance of the capacitor are so adjusted in advance as to have multiple resonance frequencies. The multifrequency antenna is characterized by yielding large gains with multiple frequencies using one antenna element.

### CITATION LIST

### Patent Literature

### [PTL 1]

Unexamined Japanese Patent Application KOKAI Publication No. 2005-086518

### SUMMARY OF INVENTION

### Technical Problem

However, the multifrequency antenna described in the Japanese Patent Application No. 2009-180009 may allow a current to flow through the grounding conductor. When a current flows through the grounding conductor, noise or energy loss occurs. Therefore, the multifrequency antenna has room for improvement in terms of prevention of a current flowing through the grounding part.

### Solution to Problem

The present invention is invented in view of the above problem and an exemplary purpose of the present invention is to provide a compact multifrequency antenna capable of transmitting/receiving radio signals of multiple frequencies and causing low energy loss.

Another exemplary purpose of the present invention is to provide a compact multifrequency antenna yielding strong emission in one direction and usable with multiple frequency bands.

In order to achieve the above purposes, the multifrequency antenna according to the present invention comprises:
a first antenna, which has multiple resonance frequencies, comprising
a first input/output terminal;
a first antenna conductor;
a series circuit including a first inductor and a first capacitor connects said first input/output terminal and said first antenna conductor; and
a second inductor connected to said first antenna conductor at one end; and
a second antenna, which has multiple resonance frequencies, comprising
a second input/output terminal;
a second antenna conductor;
a series circuit including a third inductor and a second capacitor connects said second input/output terminal and said second antenna conductor; and
a fourth inductor connected to (i) said second antenna conductor at one end and (ii) the other end of said second inductor at the other end;
wherein a primary radio wave propagation direction of said first antenna conductor and a primary radio wave propagation direction of said second antenna conductor are substantially the same.

### Advantageous Effects of Invention

The present invention can provide a multifrequency antenna whose gain for the principal polarized wave is large and which is usable with multiple frequency bands.

### BRIEF DESCRIPTION OF DRAWINGS

FIG. 1 is a perspective view of a multifrequency antenna according to Embodiment 1 of the present invention.

FIG. 2 is a plane view of the multifrequency antenna shown in FIG. 1.

FIG. 3 is a bottom view of the multifrequency antenna shown in FIG. 1.

FIG. 4 is a cross-sectional view of the multifrequency antenna shown in FIG. 1.

FIG. 5 is an illustration showing a part of the equivalent circuit of the multifrequency antenna shown in FIG. 1.

FIG. 6 is an illustration showing the entire equivalent circuit of the multifrequency antenna shown in FIG. 1.

FIG. 7 is a graphic expression showing the frequency characteristics on reflection loss of the multifrequency antenna shown in FIG. 1.

FIG. 8-A is an illustration showing the directionality of the multifrequency antenna shown in FIG. 18.

FIG. 8-B is an illustration showing the directionality of the multifrequency antenna shown in FIG. 1.

FIG. 9 is a plane view of a multifrequency antenna according to Embodiment 2 of the present invention.

FIG. 10 is an illustration showing the directionality of the multifrequency antenna shown in FIG. 9.

FIG. 11 is a plane view of a multifrequency antenna according to Embodiment 3 of the present invention.

FIG. 12 is an illustration showing the directionality of the multifrequency antenna shown in FIG. 11.

FIG. 13 is a plane view of a multifrequency antenna according to Embodiment 4 of the present invention.

FIG. 14 is an illustration showing an application of the multifrequency antenna shown in FIG. 13.

FIG. 15 is a plane view of a multifrequency antenna according to Embodiment 5 of the present invention.

FIG. 16 is a cross-sectional view of the multifrequency antenna shown in FIG. 15.

FIG. 17 is an illustration showing an application of the multifrequency antenna shown in FIG. 9.

FIG. 18 is a perspective view of a prior art multifrequency antenna.

### DESCRIPTION OF EMBODIMENTS

### Embodiment 1

A multifrequency antenna 100 according to Embodiment 1 of the present invention will be described hereafter.

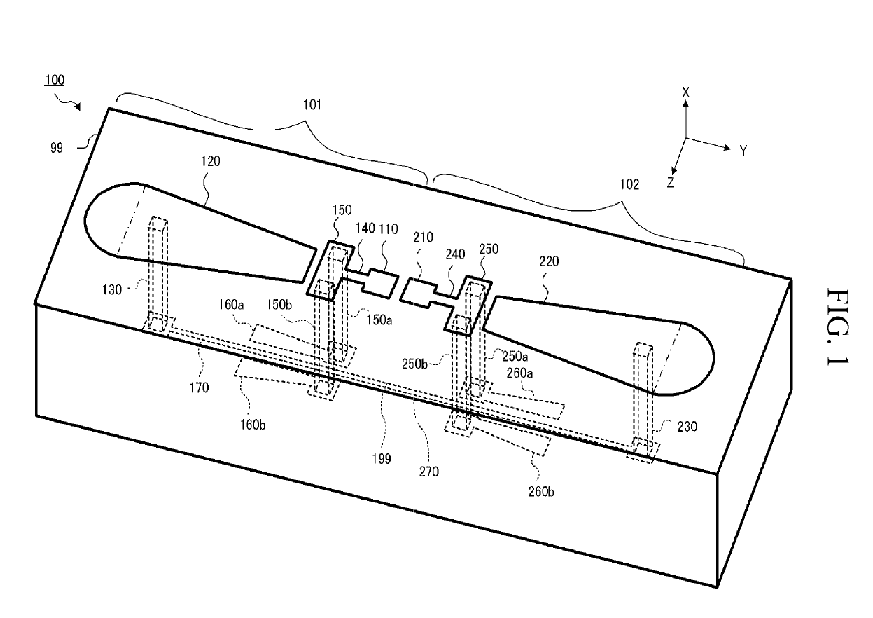

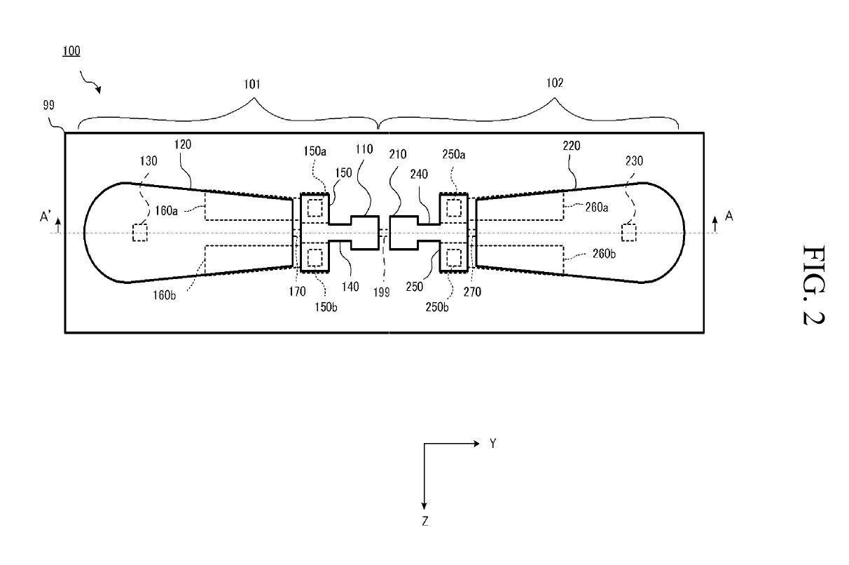

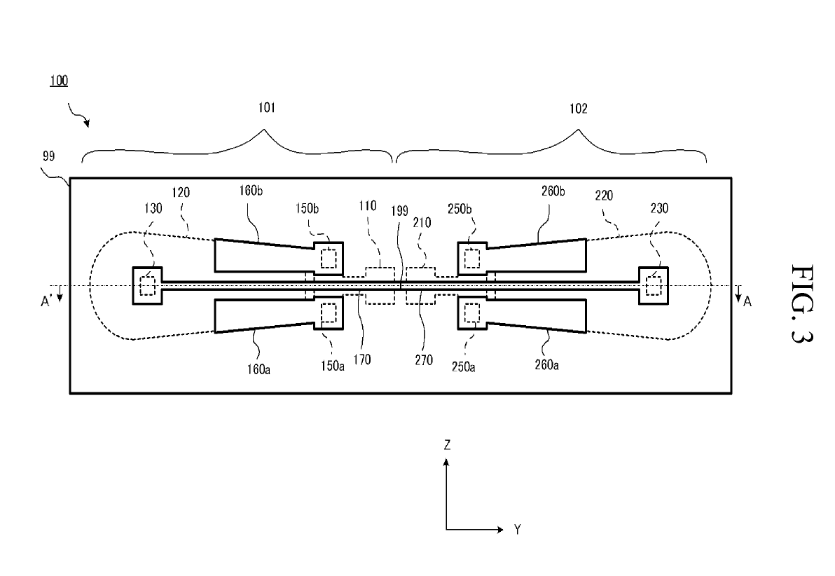

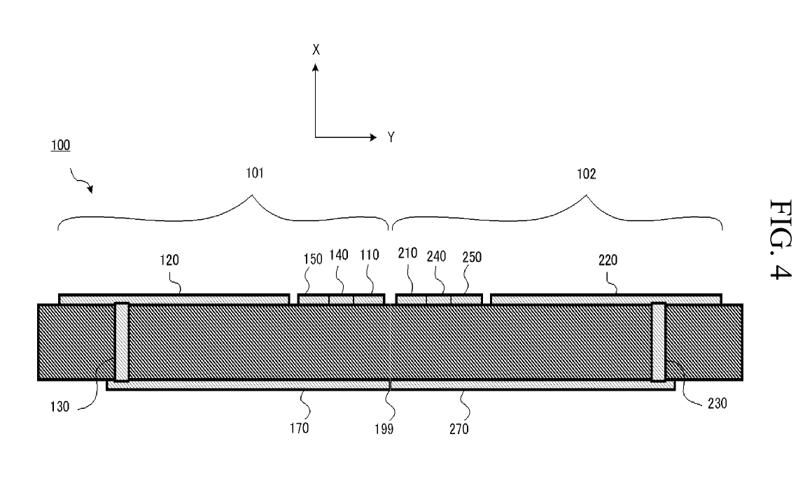

First, the structure of the multifrequency antenna 100 according to Embodiment 1 will be described with reference to FIGS. 1 to 4. FIG. 1 is a perspective view of the multifrequency antenna 100. FIG. 2 is a plane view of the multifrequency antenna 100. FIG. 3 is a bottom view of the multifrequency antenna 100. FIG. 4 is a cross-sectional view of the antenna 100 at the line A-A′ in FIGS. 2 and 3. Here, the X-, Y-, and Z-axes each indicate the same directions in these figures. The X-axis is parallel to the height direction of the antenna 100. The Y-axis is parallel to the long side direction. The Z-axis is parallel to the short side direction.

As shown in the figures, the multifrequency antenna 100 comprises a substrate 99 and multifrequency antennas 101 and 102.

The substrate 99 is a dielectric plate and comprises, for example, a glass epoxy board (FR4).

The multifrequency antennas 101 and 102 have the same structure. They are provided on the substrate 99 nearly in a mirror image symmetric manner so that the emitted electromagnetic waves have the same primary propagation direction. The multifrequency antennas 101 and 102 each comprise an input/output terminal 110 or 210, an antenna element 120 or 220, vias 130, 150a, and 150b or 230, 250a, and 250b, a via conductor 150 or 250, a series inductor conductor 140 or 240, series capacitor conductors 160a and 160b or 260a and 260b, and a shunt inductor conductor 170 or 270.

The antenna elements 120 and 220 each comprise a conductor plate in the shape of a isosceles trapezoid of which the lower base is longer than the upper base and a semicircular conductor plate connected to the lower base of the isosceles trapezoid. The antenna elements 120 and 220 are provided on one main surface of the substrate 99 in the manner that the upper bases of their isosceles trapezoids face each other.

The vias 130 and 230 are each formed through the substrate 99 from the one main surface to the other nearly at the intersecting point of two diagonals of the isosceles trapezoid constituting the antenna element 120 or 220. The vias 130 and 230 are each filled with a conductor connected to the antenna element 120 or 220 at one end.

The shunt inductor conductors 170 and 270 are each comprises a line conductor extending on the other main surface of the substrate 99 and connected to the other end of the via 130 or 230 at one end. The other ends of the shunt inductor conductors 170 and 270 are connected to each other at a connection point 199 nearly at the center of the other main surface of the substrate 99. In other words, the multifrequency antennas 101 and 102 are connected to each other at the connection point 199.

The series capacitor conductors 160a and 160b are so provided on either side of the shunt inductor conductor 170 on the other main surface of the substrate 99 as to face a part of the antenna element 120. The part of the antenna element 120, the facing parts of the series capacitor conductors 160a and 160b, and the part of the substrate 99 situated in between form a series capacitor series-connected to the antenna elements 120 and 220.

Similarly, the series capacitor conductors 260a and 260b are so provided on either side of the shunt inductor conductor 270 on the other main surface of the substrate 99 as to face a part of the antenna element 220. The part of the antenna element 220, the facing parts of the series capacitor conductors 260a and 260b, and the part of the substrate 99 situated in between form a series capacitor series-connected to the antenna element 220.

The via conductors 150 and 250 are each provided on the one main surface of the substrate 99 and connected to the series capacitor conductors 160a and 160b or 260a and 260b via two vias 150a and 150b or 250a and 250b formed through the substrate 99 from the one main surface to the other.

The series inductor conductors 140 and 240 each comprise a line conductor formed on the one main surface of the substrate 99 and connected to the via conductor 150 or 250 at one end.

The input/output terminals 110 and 210 are formed close to each other neatly at the center of the one main surface of the substrate 99 and each connected to the other end of the series inductor conductor 140 or 240 at one end. A not-shown pair of feed wires is connected to the input/output terminals 110 and 210 to supply differential signals. The input/output terminals 110 and 210 serve as the feed point. The multifrequency antenna 100 emits transmission signals supplied to the input/output terminals 110 and 210 to the space as radio waves. Furthermore, the multifrequency antenna 100 converts received radio waves to electric signals and transfers them to the feed line through the input/output terminals 110 and 210.

The multifrequency antenna 100 having the above structure is produced, for example, by opening the vias 130, 150a, 150b, 230, 250a, and 250b in the substrate 99, filling the openings by plating, attaching a copper foil on either side of the substrate 99, and patterning the copper foils by PEP (Photo Etching Process).

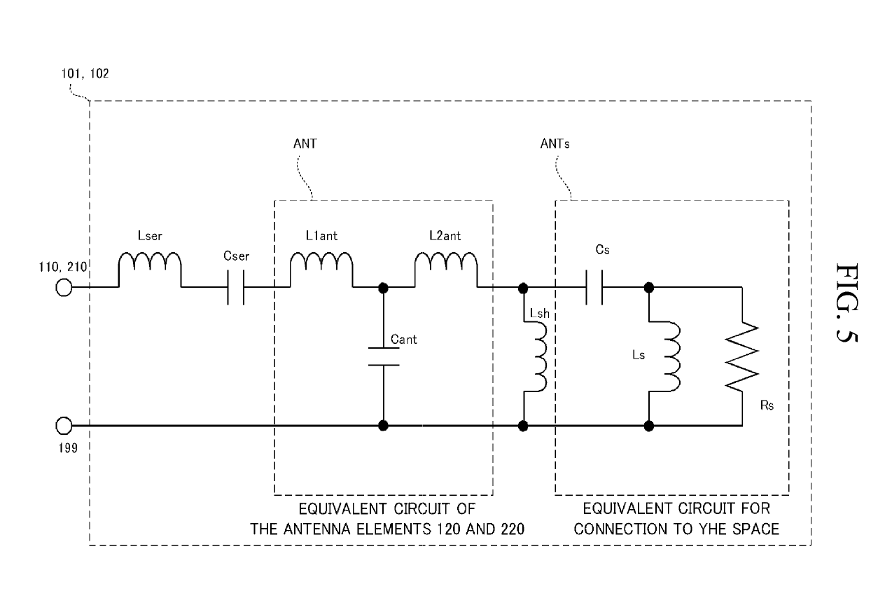

The multifrequency antennas 101 and 102 of the multifrequency antenna 100 having the above physical structure have the electrical structure presented by the equivalent circuit shown in FIG. 5.

As shown in the figure, the multifrequency antennas 101 and 102 each electrically comprise a series inductor Lser, a series capacitor Cser, an equivalent circuit ANT of the antenna element 120 or 220, a shunt inductor Lsh, an equivalent circuit ANTs for connection to the space, the input/output terminal 110 or 210, and the connection point 199.

Here, the series inductor Lser corresponds to the series inductor conductor 140 or 240, and the shunt inductor Lsh corresponds to the shunt inductor conductor 170 or 270. Furthermore, the series capacitor Cser corresponds to a series capacitor formed by the series capacitor conductors 160a and 160b or 260a and 260b.

The equivalent circuit ANT of the multifrequency antennas 101 and 102 is a circuit presenting the input impedance of the antenna element 120 or 220 as a right-handed line, comprising inductors L1ant and L2ant and a capacitor Cant.

The equivalent circuit ANTs for connection to the space is a circuit presenting the impedance due to connection between the antenna element 120 or 220 and the space, which depends on the size and shape of the antenna elements 120 and 220. The equivalent circuit ANTs for connection to the space comprises a capacitor Cs, a reference impedance Rs, and an inductor Ls.

As shown in FIG. 5, one end of the series circuit comprising the series inductor Lser and series capacitor Cser is connected to the input/output terminal 110 or 120.

One end of the inductor L1ant constituting the equivalent circuit ANT of the multifrequency antenna 101 or 102 is connected to the other end of the series circuit comprising the series inductor Lser and series capacitor Cser. One end of the capacitor Cant and one end of the inductor L2ant are connected to the other end of the inductor L1ant. The other end of the capacitor Cant is connected to the connection point 199.

One end of the shunt inductor Lsh is connected to the other end of the inductor L2ant. The other end of the shunt inductor Lsh is connected to the connection point 199.

One end of the capacitor Cs of the equivalent circuit ANTs for connection to the space is connected to the connection point between the other end of the inductor L2ant and the one end of the shunt inductor Lsh. One end of the inductor Ls and one end of the reference impedance Rs are connected to the other end of the capacitor Cs. The other end of the inductor Ls and the other end of the reference impedance Rs are connected to the connection point 199.

The capacitance of the capacitor Cs and the inductance of the inductor Ls of the equivalent circuit ANTs for connection to the space depend on the radius a of a sphere including the antenna element 120 or 220 and the reference impedance Rs and they are presented by the following equations (1) and (2):

Cs=a/(c×Rs) (1)

Ls=(a×Rs)/c (2)

in which Cs: capacitance of the capacitor Cs [F];
Ls: inductance of the inductor Ls [H];
Rs: resistance value of the reference impedance Rs [Ohm];
a: radius of a sphere including the antenna element [m]; and
c: light speed [m/s]

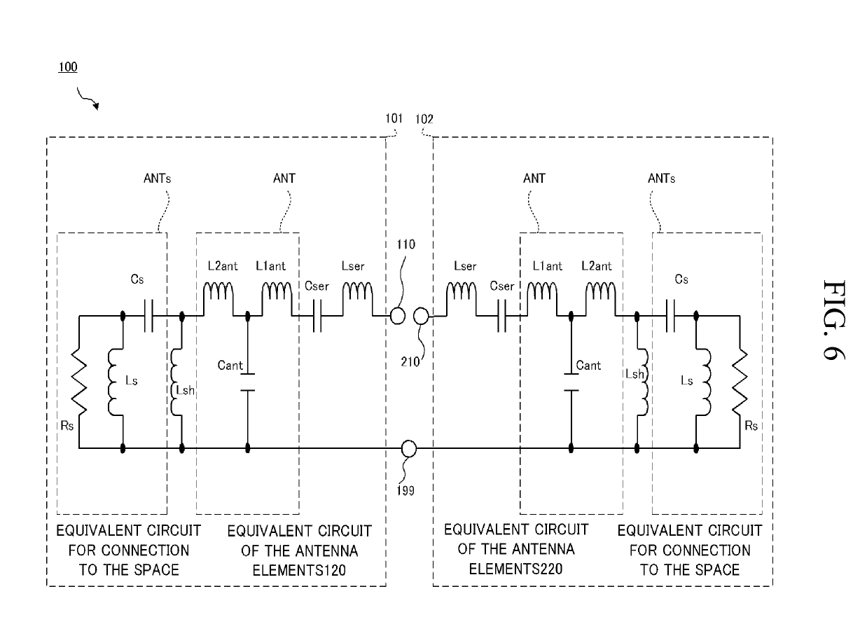

The multifrequency antennas 101 and 102 are connected to each other at the connection point 199 as described above. Similarly, the equivalent circuit of the multifrequency antenna 100 comprising the multifrequency antennas 101 and 102 is configured by mutual connection at the connection point 199 as shown in FIG. 6 and a not-shown pair of feed lines is connected to the input/output terminals 110 and 210.

The patterns of the shunt inductor conductors 170 and 270, series capacitor conductors 160a, 160b, 260a, and 260b, series inductor conductors 140 and 240 of the multifrequency antenna 100 are adjusted so that the equivalent circuit shown in FIG. 6 has an input impedance of which the imaginary part is 0 and the real part is 50 Ohm for each frequency used with the multifrequency antenna 100.

In this embodiment, the patterns are adjusted so that an input impedance of which the imaginary part is 0 and the real part is 50 Ohm is obtained for two frequencies, 2.5 GHz and 5.2 GHz.

Here, the inductances of the inductors and capacitances of the capacitors of the equivalent circuits ANTs for connection to the space in the antenna elements 120 and 220 are obtained by the above equations (1) and (2).

Then, the frequency characteristics on reflection loss of the multifrequency antenna 100 having the above physical structure and electrical structure will be described hereafter.

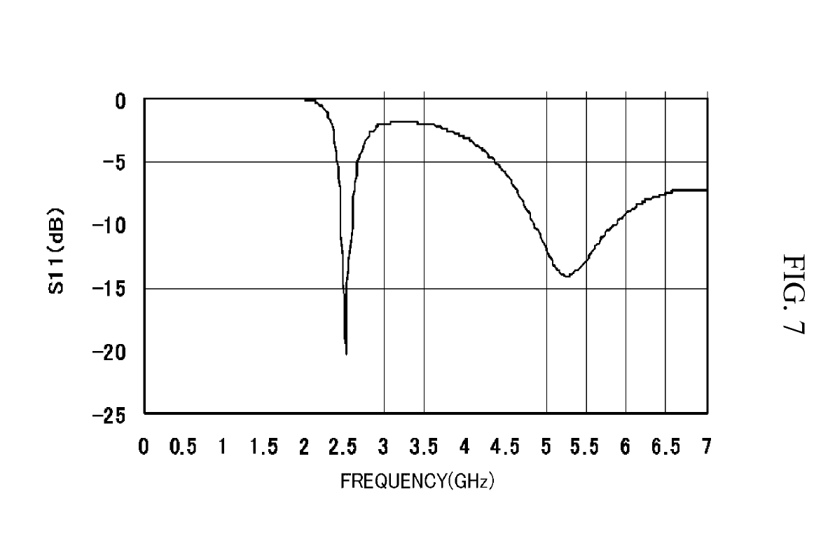

FIG. 7 shows the frequency characteristics on reflection loss of the multifrequency antenna 100. Those are the frequency characteristics on reflection loss of the multifrequency antenna 100 when the shunt inductor Lsh has an inductance of 5.1 nH, the series capacitor Cser has a capacitance of 0.16 pF, the series inductor Lser has an inductance of 5.7 nH, and the input impedance for the frequencies of 2.5 GHz and 5.2 GHz is 50 Ohm.

In FIG. 7, the frequency (GHz) is plotted as abscissa and the reflection loss S11 (dB) is plotted as ordinate.

As described above, the equivalent circuit of the multifrequency antenna 100 has an input impedance of which the imaginary part is 0 for the frequencies of 2.5 GHz and 5.2 GHz. Therefore, the multifrequency antenna 100 resonates at these frequencies and yields large gains. Then, as shown in FIG. 7, the reflection loss S11 is smaller than −10 dB for two frequency bands around 2.5 GHz and 5.2 GHz. In this way, the multifrequency antenna 100 serves as a multifrequency antenna yielding sufficient gains for two frequencies, 2.5 GHz and 5.2 GHz.

The polarized wave characteristics of the multifrequency antenna 100 having the above physical structure and electrical structure will be described hereafter. For easier understanding, comparison will be made with the multifrequency antenna 900 described in the Japanese Patent Application No. 2009-180009. Here, the multifrequency antenna 900 corresponds to the multifrequency antennas 101 and 102 of the present invention.

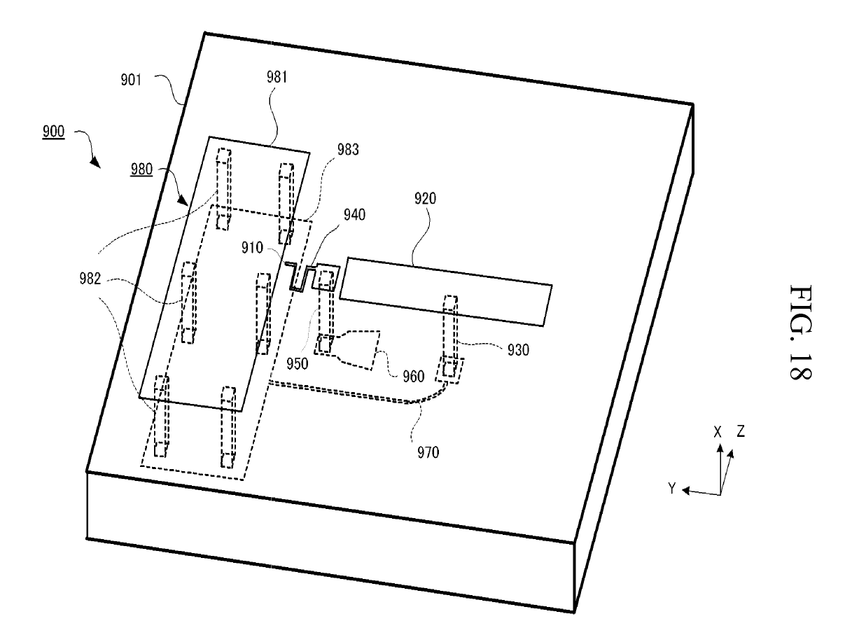

The multifrequency antenna 900 comprises, as shown in FIG. 18, a substrate 901, a feed point 910, an antenna element 920, vias 930 and 950, a series inductor conductor 940, a series capacitor conductor 960, a shunt inductor conductor 970, and a grounding part 980.

The feed point 910 corresponds to the input/output terminal 110 and the antenna element 920 corresponds to the antenna element 120. The vias 930 and 950 correspond to the vias 130, 150a, and 150b; the series inductor conductor 940, to the series inductor conductor 140; the series capacitor conductor 960, to the series capacitor conductors 160a and 160b; and the shunt inductor conductor 970, to the shunt inductor conductor 170.

The grounding part 980 comprises a ground conductor 981 provided on one main surface of the substrate 901, a ground conductor 983 provided on the other main surface of the substrate 901, and multiple vias 982 connecting the ground conductors 981 and 983, and is grounded.

Like the multifrequency antennas 101 and 102, the multifrequency antenna 900 is presented by the equivalent circuit shown in FIG. 5 and so adjusted as to have an input impedance of which the imaginary part is 0 for two frequencies of 2.5 GHz and 5.2 GHz.

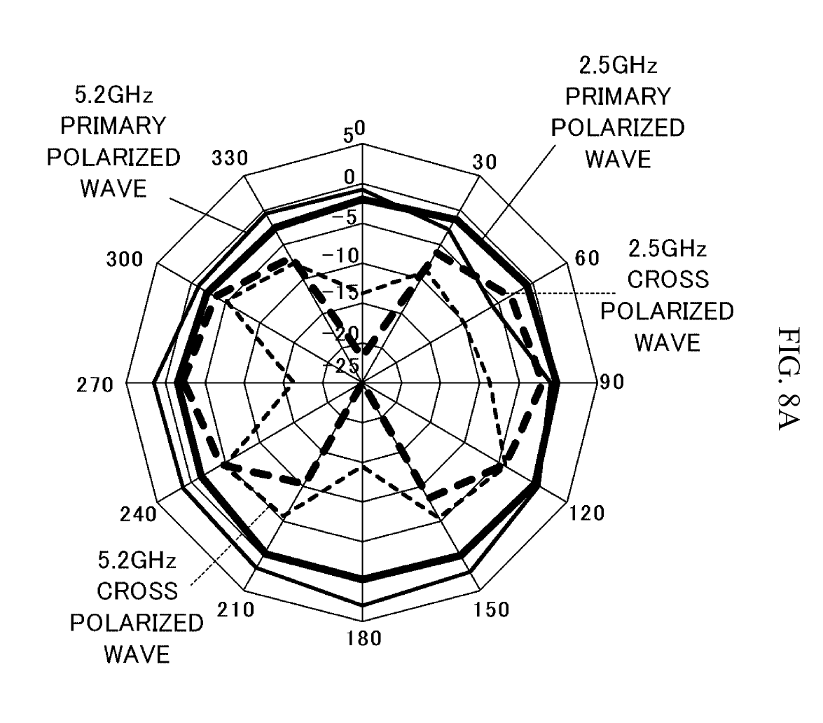

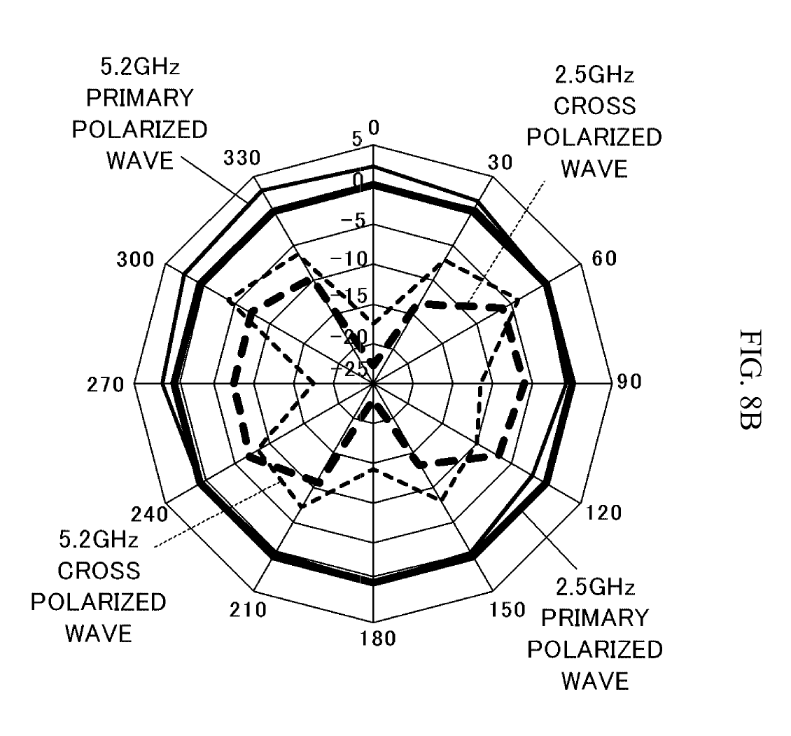

The multifrequency antenna 900 and multifrequency antenna 100 have the polarized wave characteristics as shown in FIGS. 8A and 8B, respectively.

FIG. 8A shows the emission patterns of a principal polarized wave and cross polarized wave having frequencies of 2.5 GHz or 5.2 GHz in the multifrequency antenna 900. FIG. 8B shows the emission patterns of a principal polarized wave and cross polarized wave having frequencies of 2.5 GHz and 5.2 GHz in the multifrequency antenna 100.

The emission patterns shown in FIGS. 8A and 8B present gains of the multifrequency antenna 100 in the X-Z plane of FIGS. 1 to 4. Here, the +Z-axis is directed at the degree of 0 and the +X-axis is directed at the degree of 90.

The multifrequency antenna 900 transmits a cross polarized wave that occurs as a current flows through the grounding part 980 in the Z-axis direction in addition to a principal polarized wave that occurs as a current flows through the antenna element 920 in the Y-axis direction. Therefore, as shown in FIG. 8A, the difference in gain between the principal polarized wave and cross polarized wave is 5 dB or smaller at some angles.

The multifrequency antenna 100 transmits a principal polarized wave having an electric field mostly in the Y-axis direction in the X-Z plane as a current flows through the antenna elements 120 and 220 in the Y-axis direction. Unlike the multifrequency antenna 900, the multifrequency antenna 100 has nothing corresponding to the grounding part 980 and, therefore, has a cross polarized wave less than the multifrequency antenna 900.

Therefore, as shown in FIG. 8B, the difference in gain between the principal polarized wave and cross polarized wave is 5 dB or larger at all angles in the X-Z plane. Furthermore, there is less cross polarized wave and the majority of the electric power supplied to the multifrequency antenna 100 is converted to the principal polarized wave. Consequently, the gain for the principal polarized wave is larger than in the multifrequency antenna 900.

Therefore, the multifrequency antenna 100 can yield an electromagnetic wave of nearly a single polarization for the two frequencies, 2.5 GHz and 5.2 GHz, serving as a multifrequency antenna capable of converting the supplied electric power to a principal polarized wave with high efficiency.

As described above, the multifrequency antenna 100 according to Embodiment 1 of the present invention is able to transmit/receive electromagnetic waves of nearly a single polarization for desired multiple frequencies.

The exemplary structure described above yields gains for two frequency bands, 2.5 GHz and 5.2 GHz. This embodiment is not confined thereto.

For example, any combination of two frequency bands can be used. As described above, the element constants of the equivalent circuit ANT and equivalent circuit ANTs for connection to the space of the antenna elements 120 and 220 are automatically determined according to the size of the antenna elements 120 and 220. Therefore, taking into account the element constants determined according to the size of the antenna elements 120 and 220, the inductance of the shunt inductor Lsh, capacitance of the series capacitor Cser, and inductance of the series inductor Lser are so properly determined as to create resonance points near multiple intended frequencies, whereby sufficient gains can be obtained for any multiple frequency bands.

### Embodiment 2

The above multifrequency antenna 100 according to Embodiment 1 yields large gains with a principal polarized wave in all directions on the X-Y plane. However, in some applications, strong emission in one direction is desired. The multifrequency antenna according to this embodiment yields strong emission in one direction.

A multifrequency antenna 300 according to Embodiment 2 of the present invention will be described hereafter.

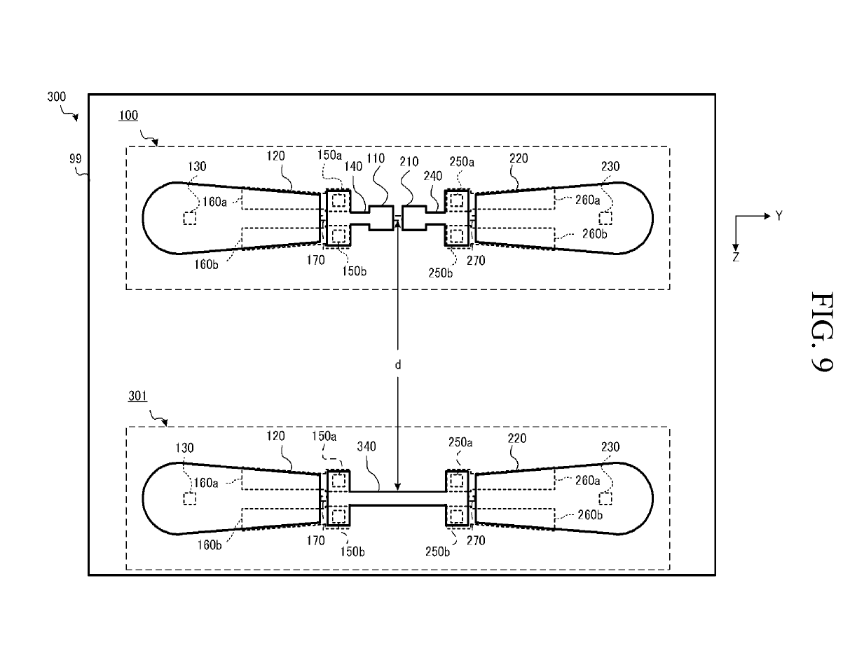

The multifrequency antenna 300 according to Embodiment 2 has on the substrate 99 a multifrequency antenna 100 and a multifrequency antenna 301 at a distance d from the multifrequency antenna 100 in the Z-axis direction as shown in FIG. 9. The multifrequency antenna 301 is an antenna wherein the input/output terminals 110 and 210 are short-circuited in the multifrequency antenna 100. More specifically, the multifrequency antenna 301 comprises a series inductor conductor 340 connected to one end of the via conductor 150 at one end and to one end of the via conductor 250 at the other end in place of the series inductor conductors 140 and 240 and input/output terminals 110 and 210. The other structure is the same as of the above multifrequency antenna 100 in Embodiment 1. The distance d is approximately 15.0 mm (approximately ⅛ wavelength at 2.5 GHz and approximately ¼ wavelength at 5.2 GHz) in this embodiment.

The equivalent circuit of the multifrequency antenna 301 is nearly the same as the equivalent circuit shown in FIG. 5 and, as in the multifrequency antenna 100, has an input impedance of which the imaginary part is 0 for the frequencies of 2.5 GHz and 5.2 GHz.

The operation of the multifrequency antenna 300 having the above structure will be described hereafter. For easier understanding, the operation in the case of the multifrequency antenna 100 emitting 2.5 GHz electromagnetic waves will be described in detail.

The multifrequency antenna 100 shown in FIG. 9 converts the electric power supplied to the input/output terminals 110 and 210 to electromagnetic waves and emits them. An electromagnetic wave emitted from the multifrequency antenna 100 in the +Z-axis direction enters the multifrequency antenna 300 situated at a distance d. Here, it is assumed that the electromagnetic wave has a phase constant B (rad/m). Then, the electromagnetic wave entering the multifrequency antenna 300 has the phases changed by −B*d (rad) while it travels the distance d.

The magnetic field of the entered electromagnetic wave induces a current in the multifrequency antenna 301. The induced current resonates in the multifrequency antenna 301 and an electromagnetic wave is emitted again. The electromagnetic wave emitted from the multifrequency antenna 301 has the phase changed approximately by pi from that of the electromagnetic wave emitted from the multifrequency antenna 100 in the +Z-axis direction. In other words, the electromagnetic wave emitted from the multifrequency antenna 301 has the phase changed by pi−B*d compared with the electromagnetic wave emitted from the multifrequency antenna 100.

In the region extending from the multifrequency antenna 301 in the +Z-axis direction, the electromagnetic wave emitted from the multifrequency antenna 100 and having the phase changed by −B*d and the electromagnetic wave emitted from the multifrequency antenna 301 and having the phase changed by pi−B*d overlap.

Having the phases shifted by pi from each other, the two electromagnetic waves cancel each other. Therefore, the electromagnetic wave emitted from the multifrequency antenna 301 in the +Z-axis direction creates almost no electric field. In other words, the electromagnetic wave emitted in parallel to the +Z-axis direction is substantially blocked by the multifrequency antenna 301.

On the other hand, an electromagnetic wave emitted from the multifrequency antenna 301 in the −Z-axis direction has the phase changed by −B*d while it travels the distance d and reaches the multifrequency antenna 100. In other words, the electromagnetic wave has the phase changed by pi−2*B*d and returns to the multifrequency antenna 100.

Therefore, the electromagnetic wave emitted from the multifrequency antenna 100 and the electromagnetic wave emitted from the multifrequency antenna 301 and having the phase changed by pi−2*B*d are combined in the −Z-axis direction from the multifrequency antenna 100.

Here, for easier understanding, it is assumed that the electromagnetic wave emitted from the multifrequency antenna 100 is sin X. The combined wave of the electromagnetic wave sin X emitted from the multifrequency antenna 100 and the electromagnetic wave sin (X+A) emitted from the multifrequency antenna 301 (here, A=pi−2*B*d) is sing X+sin (X+A)=2*sin (X+A/2)*cos (A/2). When A/2 ranges from −pi/3 to pi*3, cos (A/2)>½, then satisfying 2*sin (X+A/2)*cos (A/2)>sin (X+A/2). In other words, when A/2 ranges from −pi/3 to pi*3, the electromagnetic waves emitted from the multifrequency antenna 100 and the electromagnetic waves emitted from the multifrequency antenna 301 intensify each other. In other words, when A(=pi−2*B*d) ranges from −2pi/3 to 2pi/3, two electronic waves intensify each other. When an electromagnetic wave emitted from the multifrequency antenna 100 and an electromagnetic wave emitted from the multifrequency antenna 301 have the same phase (A=0), they particularly intensify each other.

In this embodiment, the distance d is 15.0 mm (approximately ⅛ wavelength at 2.5 GHz and approximately ¼ wavelength at 5.2 GHz). Therefore, A=0 in the case of 5.2 GHz and A=pi/2 in the case of 2.5 GHz; the electromagnetic waves emitted from the multifrequency antenna 100 and the electromagnetic waves emitted from the multifrequency antenna 301 intensify each other.

As described above, the multifrequency antenna 301 serves as a reflector blocking/reflecting electromagnetic waves emitted from the multifrequency antenna 100 in the +Z-axis direction.

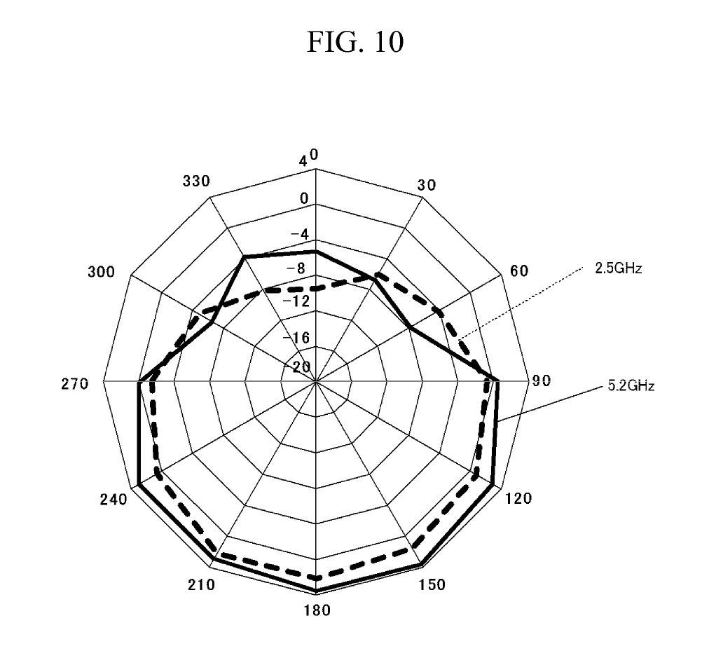

The multifrequency antenna 300 of this embodiment has the directionality shown in FIG. 10. In the figure, the solid line presents the directionality for a frequency of 5.2 GHz and the dotted line presents the directionality for a frequency of 2.5 GHz. Here, the +Z-axis is directed at the degree of 0 and the +X-axis is directed at the degree of 90.

As described above, the electromagnetic waves emitted from the multifrequency antenna 100 in the +Z-axis direction are substantially blocked by the multifrequency antenna 301. Therefore, as shown in FIG. 10, the multifrequency antenna 300 yields small gains in the +Z-axis direction (the direction at the degree of 0).

Furthermore, the electromagnetic waves emitted from the multifrequency antenna 100 in the −Z-axis direction and the electromagnetic waves emitted from the multifrequency antenna 301 in the −Z-axis direction intensify each other as described above. Therefore, as shown in FIG. 10, the multifrequency antenna 300 yields large gains in the −Z-axis direction (the direction at the degree of 180).

Therefore, the multifrequency antenna 300 serves as a highly directional antenna emitting electromagnetic waves of nearly a single polarization for frequencies of 2.5 GHz and 5.2 GHz.

As described above, Embodiment 2 of the present invention allows for communication with electromagnetic waves of nearly a single polarization for multiple desired frequencies. Then, a highly directional multifrequency antenna for multiple frequencies can be provided.

In the exemplary structure described above, the resonance frequencies of the multifrequency antenna 301 are the same frequencies as those of the multifrequency antennas 101 and 102. However, it is unnecessary that they are the same frequencies. The reflection phase of the multifrequency antenna 301 can be altered by changing the resonance frequency of the multifrequency antenna 301, whereby the multifrequency antenna 300 has a desired directionality.

### Embodiment 3

In the above embodiment 2, the multifrequency antenna 301 having the same shape as the multifrequency antenna 100 is used as a reflector. However, a dipole antenna having a resonance frequency for a single frequency can be used in place of the multifrequency antenna 301.

A multifrequency antenna 500 according to Embodiment 3 of the present invention will be described hereafter.

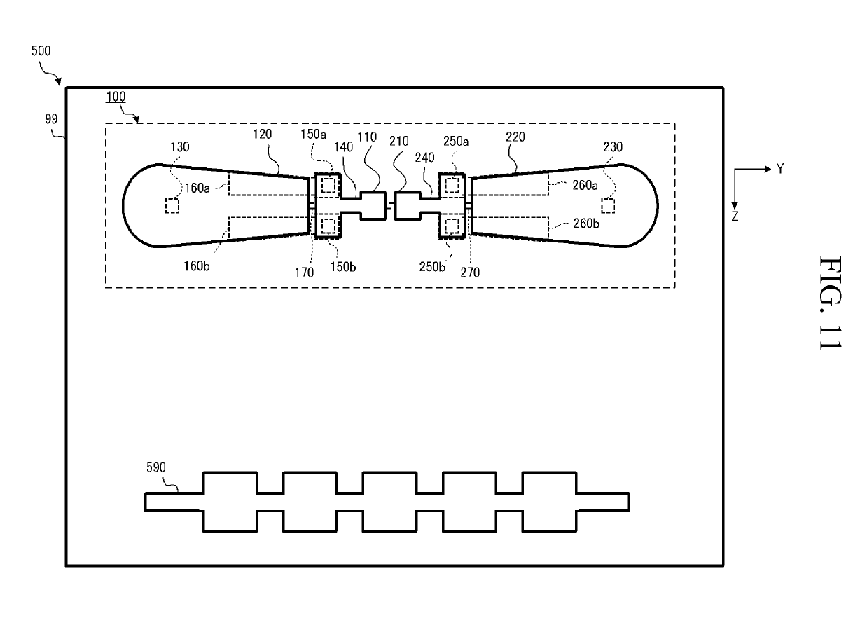

In the multifrequency antenna 500, as shown in FIG. 11, the multifrequency antenna 301 of the multifrequency antenna 300 in Embodiment 2 is replaced by a reflective pattern 590 comprising a dipole antenna having rectangular patterns. The other structure is the same as of the multifrequency antenna 300.

The reflective pattern 590 comprises capacitance-loaded rectangular patterns on an elongated line. The reflective pattern 590 has a resonance frequency determined by the width and length of the line and the width and length of the rectangular patterns. The reflective pattern 590 of this embodiment has a resonance frequency of 5.2 GHz.

The directionality of the multifrequency antenna 500 will be described hereafter.

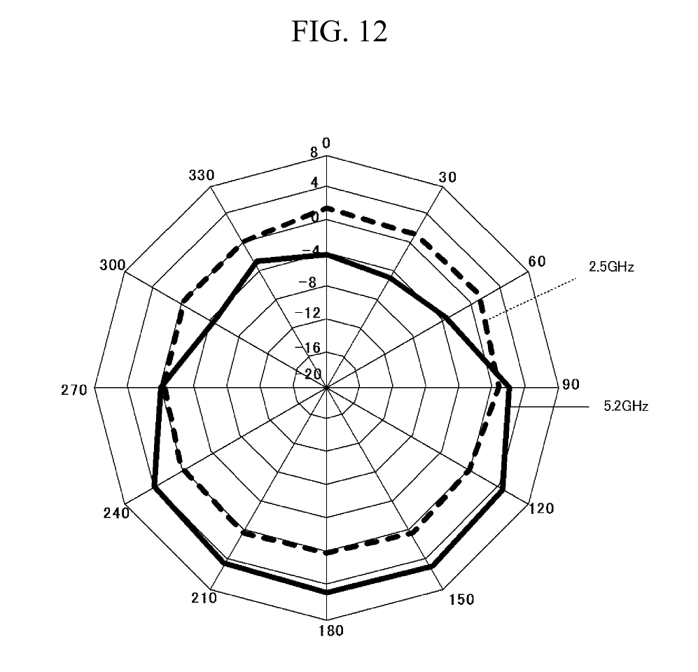

In this embodiment, the reflective pattern 590 has a resonance frequency of 5.2 GHz and blocks/reflects a 5.2 GHz electromagnetic wave. Therefore, as shown in FIG. 12, the gain in the −Z-axis direction (the direction at the degree of 180) is larger than the gain in the +Z-axis direction (the direction at the degree of 0) by approximately 8 dB or more for 5.2 GHz. On the other hand, the reflective pattern 590 does not resonate with 2.5 GHz. Therefore, the gains in the +Z-axis direction and in the −Z-axis direction are nearly equal. Then, the multifrequency antenna 500 has directionality nearly uniform in all directions for a frequency of 2.5 GHz and serves as a highly directional antenna in the −Z-axis direction for a frequency of 5.2 GHz.

As described above, Embodiment 3 of the present invention allows for communication with electromagnetic waves of nearly a single polarization for multiple desired frequencies. Then, a highly directional multifrequency antenna for specific frequencies can be provided.

The exemplary structure described above presents a structure highly directional for one frequency band of 5.2 GHz. However, this is not restrictive.

For example, multiple reflective patterns 590 having resonance frequencies corresponding to different frequencies can be provided.

### Embodiment 4

The multifrequency antenna according to this embodiment further comprises reflecting conductors in addition to the structure of the multifrequency antenna 300 or 500 in the above Embodiment 2 or 3. The reflecting conductors are used to reflect electromagnetic waves diagonally travelling from the multifrequency antenna 100 to the reflector (the multifrequency antenna 300 or the reflective pattern 590) toward the reflector.

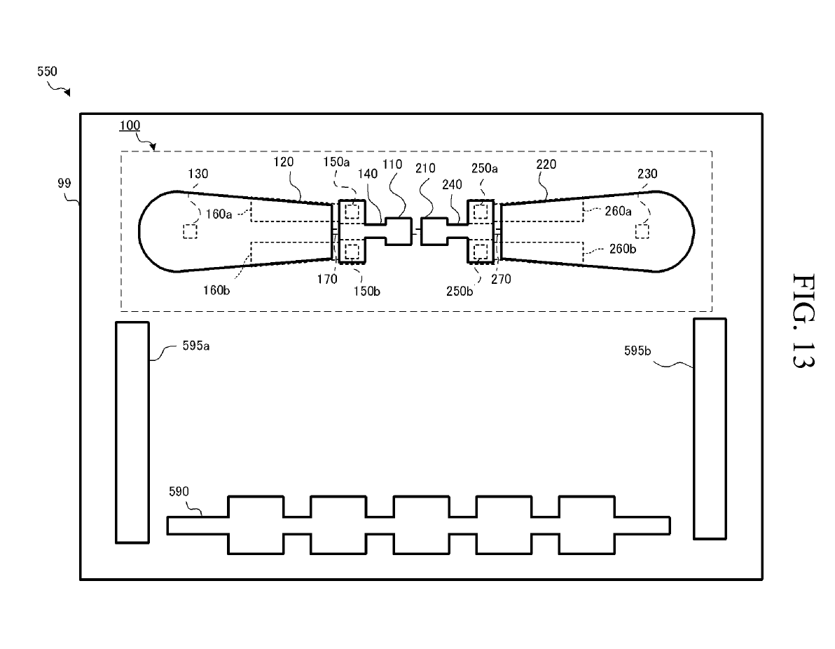

A multifrequency antenna 550 according to this embodiment will be described hereafter. In the multifrequency antenna 550, as shown in FIG. 13, reflective patterns 595a and 595b extending on one main surface of the substrate 99 in parallel to the Z-axis are further provided to the structure of the multifrequency antenna 500 in Embodiment 3.

The electromagnetic waves traveling in parallel to the +Z-axis enter the reflective pattern 590 under no influence of the reflective patterns 595a and 595b because their electric field is perpendicular to them. On the other hand, the electromagnetic waves travelling diagonally to the +Z-axis are reflected by the reflective patterns 595a and 595b and enter the reflective pattern 590. Therefore, in addition to the electromagnetic waves travelling in parallel to the +Z-axis, the electromagnetic waves travelling diagonally to the +Z-axis enter the reflective pattern 590, allowing the reflective pattern 590 to reflect more electromagnetic waves.

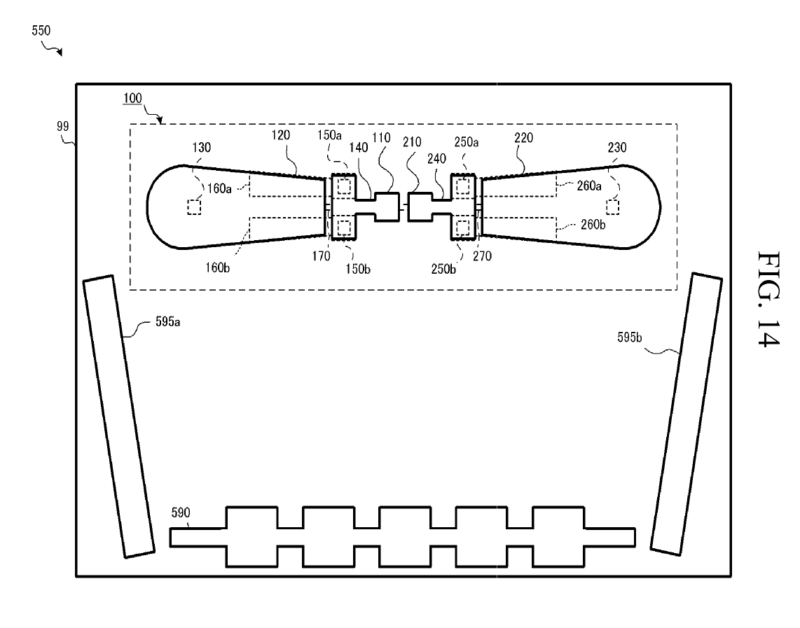

Here, the reflective patterns 595a and 595b can be provided in the manner that they become closer to each other near the reflective pattern 590 as shown in FIG. 14.

Furthermore, in the above embodiment, the reflective patterns 595a and 595b are provided to the multifrequency antenna 500 in Embodiment 3. The reflective patterns 595a and 595b can be provided to the multifrequency antenna 300 in Embodiment 2.

### Embodiment 5

From the viewpoint of geometric optics, the multifrequency antenna 100 emits electromagnetic waves from the feed point or near the input/output terminals 110 and 210. Therefore, when the reflector has the focal point near the input/output terminals 110 and 210, the electromagnetic waves emitted from the multifrequency antenna 100 are more effectively reflected by the reflector.

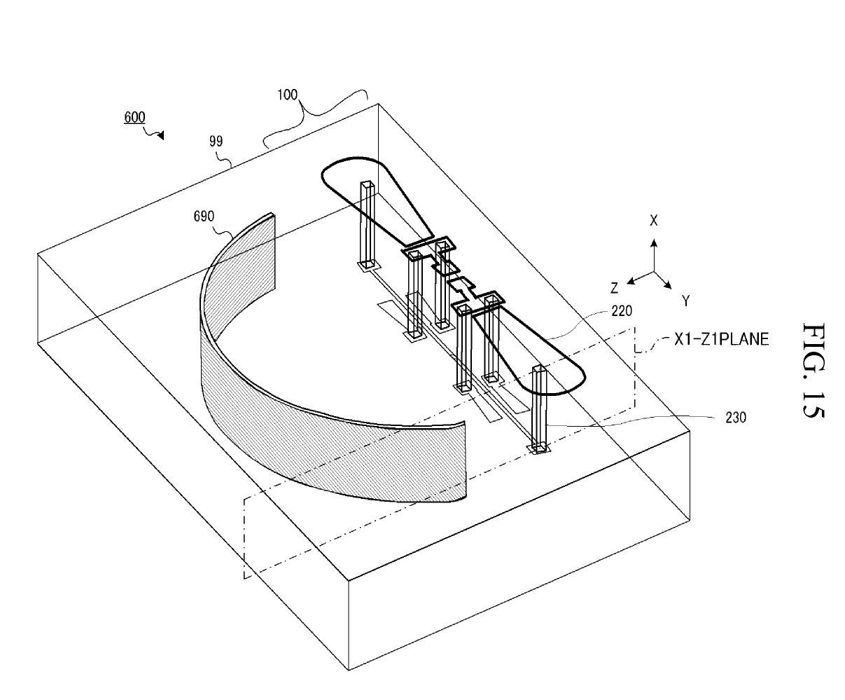

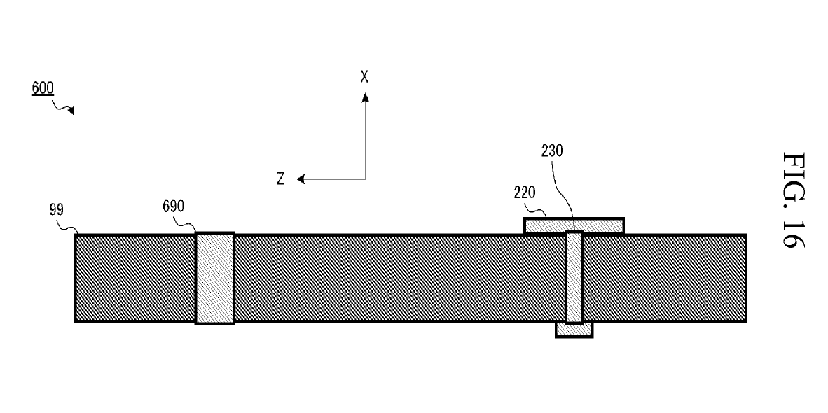

A multifrequency antenna 600 according to this embodiment will be described hereafter with reference to FIGS. 15 and 16. FIG. 15 is a perspective view of the multifrequency antenna 600. FIG. 16 is a cross-sectional view in the X1-Z1 plane shown in FIG. 15. In FIG. 15, the parts that are actually hidden are also presented by solid lines for easier viewing.

In the multifrequency antenna 600, as shown in the figure, a curved reflecting plate 690 having the focal point near the input/output terminals 110 and 210 of the multifrequency antenna 100 is provided through the substrate 99 from one main surface to the other. The other structure is the same as of the multifrequency antenna 100 in Embodiment 1.

The multifrequency antenna 600 operates as follows when it emits electromagnetic waves. Among the electromagnetic waves emitted from the multifrequency antenna 100, those entering the reflecting plate 690 are reflected in the −Z direction. The reflected electromagnetic waves and the electromagnetic waves emitted from the multifrequency antenna 100 in the −Z direction intensify each other.

On the other hand, the multifrequency antenna 600 operates as follows when electromagnetic waves enter it.

When electromagnetic waves enter the multifrequency antenna 600 in the −Z-axis direction, most of the electromagnetic waves are absorbed by the multifrequency antenna 100. The unabsorbed electromagnetic waves are partly reflected by the reflecting plate 690 and enter the input/output terminals 110 and 210 at the focal point of the reflecting plate 690.

In this way, the reflecting plate 690 can also be used to change the directionality.

Furthermore, the reflecting plate 690 has a thickness to go through the substrate 99, reflecting more electromagnetic waves compared with a copper foil pattern.

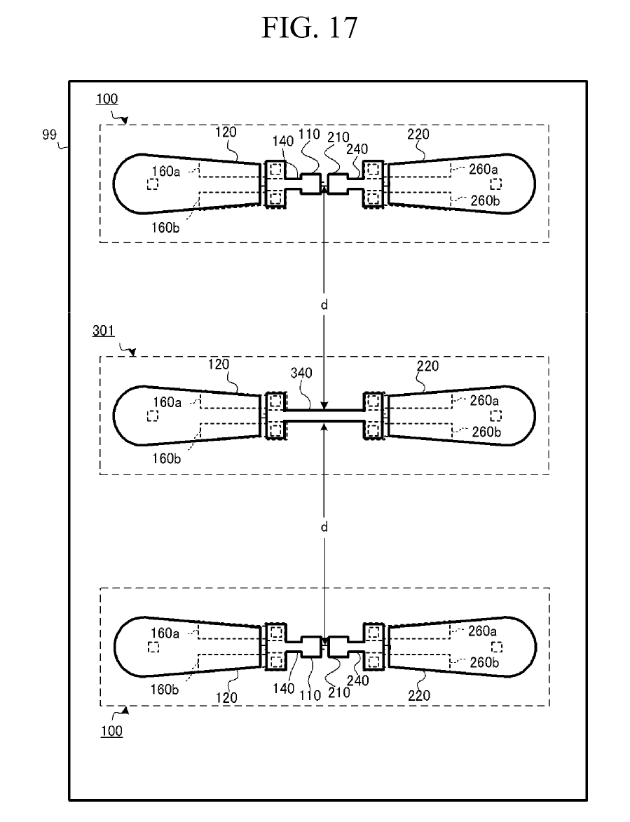

As described above, Embodiments 2 to 5 of the present invention provide a multifrequency antenna having a strong directionality in one direction for multiple desired frequencies. For example, as shown in FIG. 17, one multifrequency antenna 301 as described above can be provided between two multifrequency antennas 100 as described above to realize two multifrequency antennas 300 as described above.

Furthermore, for a system in which the other communication party is located at a limited position, the antenna can be so directed as to increase the gain in the direction to the other communication party, whereby the antenna can be used as a high gain antenna. Furthermore, in an environment where radio waves emission is an obstacle, the antenna can be directed in the manner that the direction in which the gain is suppressed matches the direction in which radio waves emission is an obstacle, whereby the antenna can be used as a less obstacle antenna.

The present invention is not confined to the above embodiments and various modifications and applications are available.

For example, in the above embodiments, the patterns provided on one main surface of the substrate 99 and the patterns provided on the other main surface are connected by vias. They can be connected by capacitive connection or inductive connection instead of vias.

Furthermore, in the above embodiments, the inductors and conductors are formed by lines (circuit patterns). For example, some or all inductors and conductors can be formed by chip parts.

Furthermore, in the above embodiments, the circuits are provided on one main surface and the other main surface of the substrate 99 by way of example. The circuits can be provided only on one main surface.

Furthermore, in the above embodiments, the circuit elements are provided on a dielectric substrate. The substrate can be eliminated as long as the circuit elements are held.

Furthermore, in the above embodiments, the multifrequency antennas 101 and 102 have the same resonance frequencies. They may have different resonance frequencies.

Having described and illustrated the principles of this application by reference to one (or more) preferred embodiment(s), it should be apparent that the preferred embodiments may be modified in arrangement and detail without departing from the principles disclosed herein and that it is intended that the application be construed as including all such modifications and variations insofar as they come within the spirit and scope of the subject matter disclosed herein.

This application claims the benefit of Japanese Patent Application No. 2010-037956, filed on Feb. 23, 2010, the entire disclosure of which is incorporated by reference herein.

1. A multifrequency antenna comprising:
a first antenna, which has multiple resonance frequencies, comprising a first input/output terminal;
a first antenna conductor;
a series circuit including a first inductor and a first capacitor connects said first input/output terminal and said first antenna conductor; and
a second inductor connected to said first antenna conductor at one end; and
a second antenna, which has multiple resonance frequencies, comprising a second input/output terminal;
a second antenna conductor;
a series circuit including a third inductor and a second capacitor connects said second input/output terminal and said second antenna conductor; and
a fourth inductor connected to (i) said second antenna conductor at one end and (ii) the other end of said second inductor at the other end;
wherein a primary radio wave propagation direction of said first antenna conductor and a primary radio wave propagation direction of said second antenna conductor are substantially the same.

2. The multifrequency antenna according to claim 1 wherein the multiple resonance frequencies of said first antenna and the multiple resonance frequencies of said second antenna are substantially the same.

3. The multifrequency antenna according to claim 1, further comprising a dielectric plate, wherein:
said first and second input/output terminals and said first and second antenna conductors are formed on one surface of said dielectric plate;
said second and fourth inductors are provided on the other surface of the dielectric plate, and the one end of said second inductor is connected to said first antenna conductor, and one end of said fourth inductor is connected to said second antenna conductor via vias;
said first capacitor comprises a part of said first antenna conductor, a first electric conductor provided on the other surface of said dielectric plate and facing the part of said first antenna conductor, and the dielectric plate situated in between;
said second capacitor comprises a part of said second antenna conductor, a second electric conductor provided on the other surface of said dielectric plate and facing the part of said second antenna conductor, and the dielectric plate situated in between;
said first inductor is provided on the one surface of said dielectric plate and connected to (i) said first electric conductor via a via at one end and (ii) said first input/output terminal at the other end; and
said third inductor is provided on the one surface of said dielectric plate and connected to (i) said second electric conductor via a via at one end and (ii) said second input/output terminal at the other end.

4. The multifrequency antenna according to claim 1, further comprising a reflector provided in a primary radio wave propagation direction of said first and second antenna conductors for blocking/reflecting radio waves emitted by said first and second antenna conductors.

5. The multifrequency antenna according to claim 4 wherein said reflector is provided at a distance where the radio waves reflected by said reflector to said first and second antenna conductors and the radio waves emitted from said first and second antenna conductors in the same direction as said radio waves intensify each other.

6. The multifrequency antenna according to claim 4 wherein:
said reflector comprises a third antenna conductor, a fourth antenna conductor, a fifth inductor connecting said third and fourth antenna conductors, and a series circuit comprising a sixth inductor and a third capacitor and connecting said third and fourth antenna conductors;
said reflector has substantially the same multiple resonance frequencies as the multiple resonance frequencies of said first and second antennas; and
the primary radio wave propagation direction of the reflector is substantially the same as the primary radio wave propagation direction of said first and second antennas.

7. The multifrequency antenna according to claim 4 wherein:
said reflector comprises a line conductor loaded with multiple rectangular patterns;
the line conductor extends in parallel to a electric field direction of primary radio waves of said first and second antennas; and
the reflector has at least one resonance frequency among the multiple resonance frequencies of said first and second antennas.

8. The multifrequency antenna according to claim 4 wherein said reflector has a curved form with a focal point situated near said first and second input/output terminals.

9. The multifrequency antenna according to claim 4, further comprising a reflecting conductor for reflecting radio waves which travel diagonally from said first and second antenna conductors to said reflector toward said reflectors.

10. The multifrequency antenna according to claim 1 wherein said first and second antennas are provided in a minor image symmetric manner.
